(19) United States
(12) Patent Application Publication
(10) Pub. No.: US 2007/0262972 A1
(43) Pub. Date: Nov. 15, 2007

(54) Gamma Correction Circuit and Display Device Including Same

(75) Inventor: Kenichi Nakata, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Ukyo-ku, Kyoto (JP)

(21) Appl. No.: 10/598,983

(22) PCT Filed: Mar. 16, 2005
(86) PCT No.: PCT/JP05/04636

§ 371 Date: Jun. 19, 2007

(30) Foreign Application Priority Data
Mar. 17, 2004 (JP) 2004-076971

(51) Int. Cl. G06F 3/038; G09G 3/36

(52) U.S. Cl. 345/204; 345/87

(57) ABSTRACT

A display device includes a gamma correction circuit that includes a gamma correction data output circuit that outputs a plurality of gamma correction data that correspond with a detected temperature, a plurality of registers that input and hold each of a plurality of gamma correction data, and a plurality of D/A converters each of which converts the data of each of the plurality of registers into an analog voltage to output gamma-corrected set voltages, a display panel driver to which image data are input and which outputs applied voltages that have been corrected correspondingly with the image data via a plurality of gamma-corrected set voltages of the gamma correction circuit, a display panel which includes display elements to which the applied voltages from the display panel driver are applied, a nonvolatile memory which saves a plurality of gamma correction data, and a temperature sensor which generates an electrical signal that corresponds with a temperature.

### BACKGROUND OF THE INVENTION

1. Field of the Invention

The present invention relates to a gamma correction circuit and relates to a display device such as a liquid crystal display device that includes the gamma correction circuit.

2. Description of the Related Art

Generally, in a display panel of a display device such as a liquid crystal display device, there is a nonlinear correlation between an applied voltage and a brightness of a display element, that is, a gamma characteristic. FIG. 3 shows a typical gamma characteristic. Solid curve A in FIG. 3 is the characteristic (that is, a gamma characteristic) of a liquid crystal display element when an applied voltage is applied as is without correcting (gamma-correcting) the image voltage (V₁ or Vₘ, for example). In FIG. 3, the horizontal axis represents the applied voltage and the vertical axis is the relative brightness (that is, the optical transmittance of the liquid crystals). Now, if the image voltage (V₁ or Vₘ, for example) is applied without being gamma-corrected, a satisfactory image cannot be displayed due to conformity with the nonlinear correlation. Hence, in order to display a satisfactory image, a corrected image voltage (VI₁ or VIₘ, for example) which is obtained by gamma-correcting the image voltage (V₁ or Vₘ, for example) in order to follow the broken straight line B which represents a linear correlation between the image voltage and the brightness is taken as the applied voltage.

Thus, a gamma correction circuit that performs gamma correction in a liquid crystal display device in this way, as disclosed in Japanese Patent Application Laid Open No. H10-108040 (Patent Document 1), Japanese Patent Application Laid Open No. H11-32237 (Patent Document 2), and U.S. Pat. No. 5,796,384 (Patent Document 3), for example, is known. Further, the present applicant proposed, in Japanese Application No. 2002-326266 which corresponds to Japanese Patent Application Laid Open No. 2004-165749(Patent Document 4), a gamma correction circuit for which the gamma correction circuits disclosed in Patent Documents 1, 2, and 3 represent the prior art. FIG. 4 shows a liquid crystal display device that has the same gamma correction circuit as that of Patent Document 4. The liquid crystal display device 101 has a gamma correction circuit 102 that outputs gamma-corrected set voltages VI₁ and VIₘ, a display panel driver 3 to which image data Di of n bits (eight bits, for example) are input and which, by selecting the corresponding gamma-corrected set voltages VI₁ to VIₘ or the interpolation voltages thereof (subsequently described), outputs a corrected image voltage V₀ as an applied voltage to each of the source lines in a display panel 4 (subsequently described), the display panel 4, and a nonvolatile memory 5 that saves gamma correction data.

The gamma correction circuit 102 includes a gamma correction data output circuit 111 that converts serial gamma correction data that are input from the outside via an input terminal SD into L-bit (10-bit, for example) parallel gamma correction data which are digital data corresponding to the gamma-corrected set voltages VI₁ to VIₘ and outputs such data; m (nine, for example) registers 112₁ to 112ₘ that input and hold the parallel gamma correction data; D/A converters (DAC) 113₁ to 113ₘ of ten bits, for example, which convert data output by the registers 112₁ to 112ₘ into analog voltages; buffers 114₁ to 114ₘ to which the analog voltages output by the D/A converters (DAC) 113₁ to 113ₘ are input and which output the gamma-corrected set voltages VI₁ to VIₘ by raising the current capacity. The gamma correction data output circuit 111 saves gamma correction data in the nonvolatile memory 5 and retrieves the data from the nonvolatile memory 5 when required.

The display panel driver 3 includes a resistance ladder 15 that generates interpolation voltages by interpolating uniformly with m′ resistances between adjacent voltages of the gamma-corrected set voltages VI₁ to VIₘ (between VI₁ and VI₂, for example) which are the outputs of the gamma correction circuit 102; a decoder 16 that outputs the corrected image voltage Vo by selecting the gamma-corrected set voltages VI₁ to VIₘ or the interpolation voltages in accordance with the n-bit image data Di. The display panel 4 to which the corrected image voltage Vo is input has 2ⁿ grayscales. That is, supposing n is 8, the display panel 4 has 256 grayscales. The value of m′ is found by 2ⁿ/(m−1). That is, supposing that n is 8 and m is 9, m′ is 32. For example, if the value of the image data Di is 0, the corrected image voltage Vo is a voltage equal to VI₁ and, if the value of the image data Di is 16, the corrected image voltage Vo is the center voltage of VI₁ and VI₂.

During an adjustment, the display of the display panel 4 is confirmed in real time and, by inputting serial gamma correction data to the gamma correction circuit 102 via the input terminal SD from the outside, the gamma-corrected set voltages VI₁ to VIₘ are adjusted to the appropriate values. Once the adjustment is completed, the adjusted gamma correction data are saved in the nonvolatile memory 5 and gamma correction data saved in the nonvolatile memory 5 are subsequently used.

In recent years, there has been a need for higher quality displays as liquid crystal display devices have become more widespread. The applications of liquid crystal display devices are diversifying and, in the case of an in-vehicle liquid crystal display device, for example, the temperature range used by the display panel is large. When the temperature range used varies greatly, the characteristics such as the viscosity of the liquid crystals are also affected and the nonlinear correlation between the applied voltage and the brightness, that is, the gamma characteristic varies. Hence, if there is a large difference between the temperature range when the liquid crystal display device is used and the temperature range during the adjustment, a satisfactory image cannot be displayed.

### SUMMARY OF THE INVENTION

In order to overcome the problems described above, preferred embodiments of the present invention provide a display device, such as a liquid crystal display device, which is capable of displaying a satisfactory image over a wide temperature range.

A gamma correction circuit according to a preferred embodiment of the present invention is a gamma correction circuit which outputs a gamma-corrected set voltage to correct an image voltage in accordance with a nonlinear correlation between an applied voltage and a brightness of a display element, the gamma correction circuit including a gamma correction data output circuit that outputs a plurality of gamma correction data in accordance with a detected temperature; a plurality of registers which input and hold a plurality of gamma correction data; and a plurality of D/A converters each of which converts the data of each of the plurality of registers into an analog voltage and output a gamma-corrected set voltage.

The gamma correction data output circuit of the gamma correction circuit preferably outputs gamma correction data that are input from the outside during an adjustment of the gamma-corrected set voltages and retrieves, from the nonvolatile memory, gamma correction data that correspond with the detected temperature after the adjustment of the gamma-corrected set voltages and outputs the gamma correction data.

The gamma correction circuit preferably performs the detection of the temperature in sync with a cycle in which one screen of the display panel is displayed.

The display device according to a further preferred embodiment of the present invention includes the gamma correction circuit according to a preferred embodiment of the present invention described above; a display panel driver to which image data are input and which outputs a corrected image voltage by selecting a gamma-corrected set voltage corresponding with the image data or an interpolation voltage thereof; a display panel which includes a display element to which the corrected image voltage from the display panel driver is applied; a nonvolatile memory which saves a plurality of gamma correction data; and a temperature sensor which generates an electrical signal that corresponds with a temperature and outputs the electrical signal to the gamma correction circuit.

According to various preferred embodiments of the present invention, the gamma correction circuit includes a gamma correction data output circuit which outputs gamma correction data corresponding with the detected temperature and, therefore, a gamma correction can be performed in accordance with the detected temperature. The display device having the gamma correction circuit is capable of a satisfactory image display over a wide temperature range.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a circuit diagram of a display device according to a preferred embodiment of the present invention.

FIG. 2 shows a constitutional example of the gamma correction data output circuit of the display device.

FIG. 3 shows a general gamma characteristic.

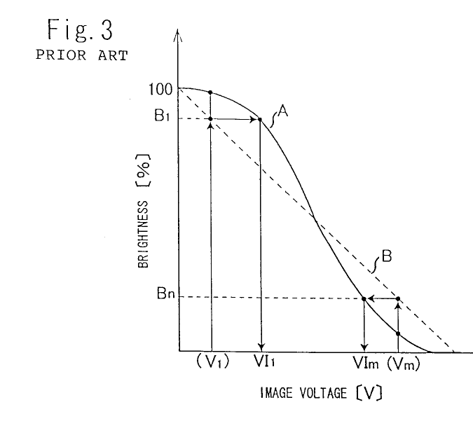

FIG. 4 is a circuit diagram of a display device of the prior art.

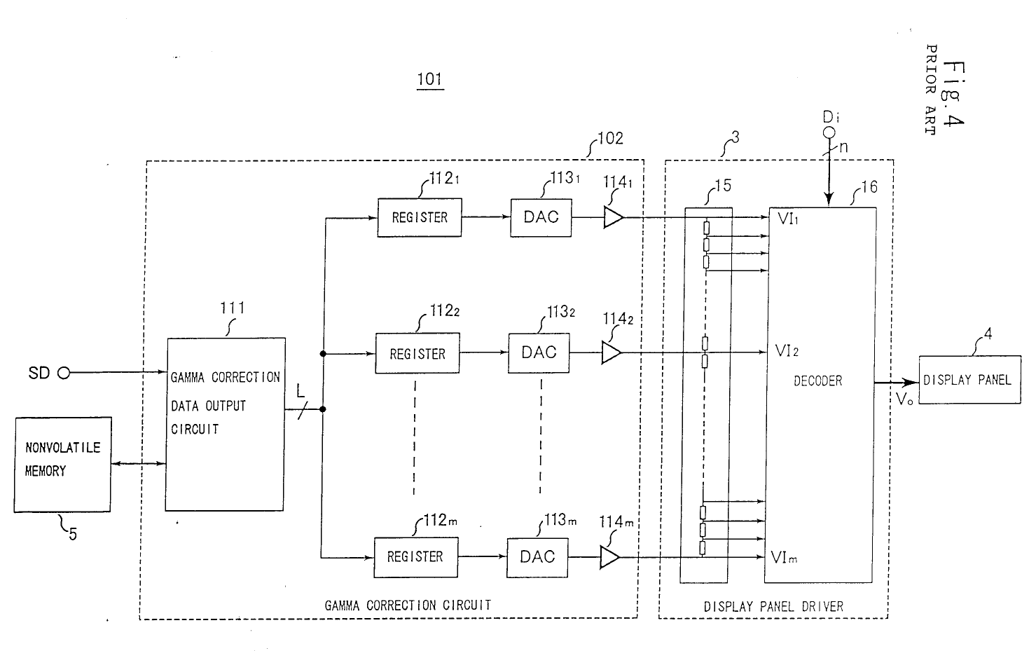

### DETAILED DESCRIPTION OF PREFERRED EMBODIMENTS

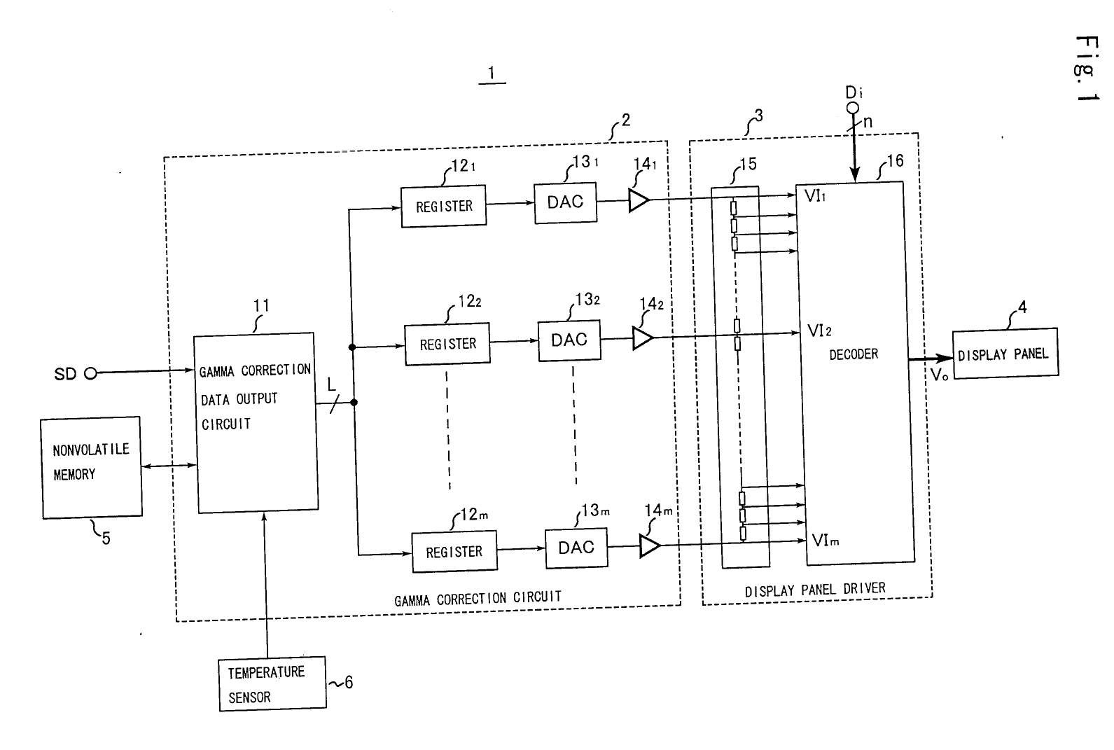

Preferred embodiments of the present invention will be described hereinbelow with reference to the drawings. FIG. 1 is a circuit diagram of a liquid crystal display device 1 according to a preferred embodiment of the present invention. The liquid crystal display device 1 has a gamma correction circuit 2 which outputs gamma-corrected set voltages VI₁ to VIₘ for correcting an image voltage in accordance with the nonlinear correlation between an applied voltage and a brightness of a liquid crystal display element, a display panel driver 3 to which image data Di of n bits (eight bits, for example) are input and which outputs a corrected image voltage Vo to each source line in the display panel 4 (subsequently described) as the applied voltage by selecting a corresponding gamma-corrected set voltage of VI₁ to VIₘ or a corresponding interpolation voltage thereof; a display panel 4 including liquid crystal display elements, a nonvolatile memory 5 that saves gamma correction data, and a temperature sensor 6 which generates an electrical signal that corresponds with a temperature and outputs the electrical signal to the gamma correction circuit 2. Here, the display panel driver 3, display panel 4, and nonvolatile memory 5 have substantially the same circuit constitution or the same structure as that of the liquid crystal display device 101 mentioned earlier.

The gamma correction circuit 2 includes a gamma correction data output circuit 11 that converts serial gamma correction data that are input from the outside via an input terminal SD into L-bit (10-bit, for example) parallel gamma correction data which are digital data corresponding to the gamma-corrected set voltages VI₁ to VIₘ and outputs such data; m (nine, for example) registers 12₁ to 12ₘ that input and hold the parallel gamma correction data; D/A converters (DAC) 13₁ to 13ₘ of ten bits, for example, which convert data output by the registers 12₁ to 12ₘ into analog voltages; buffers 14₁ to 14ₘ to which the analog voltages output by the D/A converters (DAC) 13₁ to 13ₘ are input and which output the gamma-corrected set voltages VI₁ to VIₘ by increasing the current capacity.

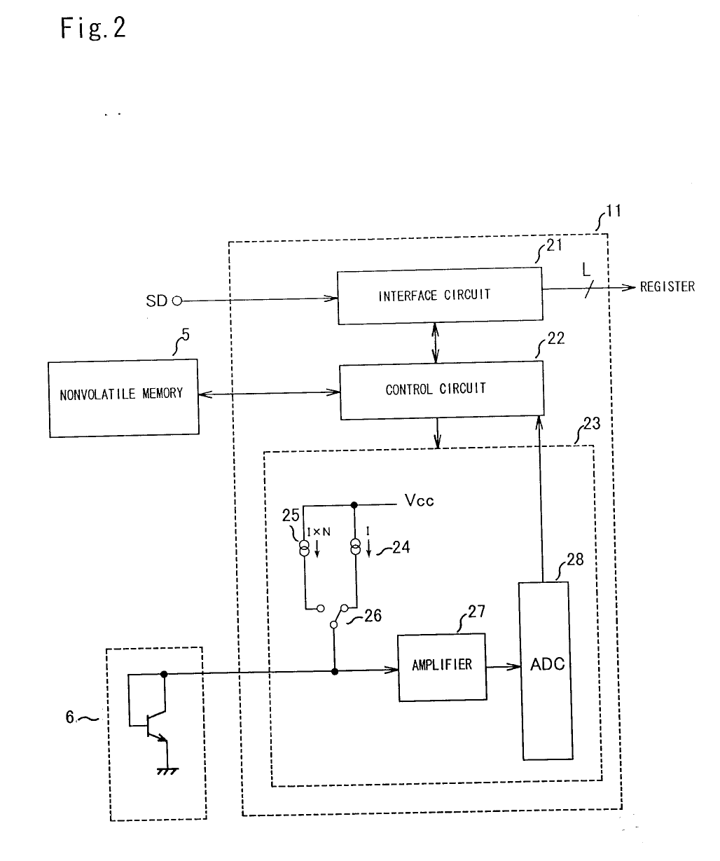

A constitutional example of the gamma correction data output circuit 11 is shown in FIG. 2. The gamma correction data output circuit 11 preferably includes an interface circuit 21, a control circuit 22, and a temperature detection circuit 23. The interface circuit 21 converts the serial gamma correction data input via the input terminal SD from the outside, when the gamma-corrected set voltages VI₁ to VIₘ are adjusted, into parallel gamma correction data and outputs the parallel gamma correction data to the registers 12₁ to 12ₘ. In addition, the gamma correction data are sent to the control circuit 22 and saved in the nonvolatile memory 5. The interface circuit 21 then receives the gamma correction data saved in the nonvolatile memory 5 from the control circuit 22 after the adjustment of the gamma-corrected set voltages VI₁ to VIₘ and outputs the gamma correction data to the registers 12₁ to 12ₘ. The control circuit 22 receives the gamma correction data from the interface circuit 21 and saves the same in the nonvolatile memory 5, and retrieves gamma correction data saved in the nonvolatile memory 5 and sends data to the interface circuit 21. The temperature detection circuit 23 detects the temperature from the electrical signal of the temperature sensor 6 constituted by a diode-connected transistor, for example, and is controlled by the control circuit 22. The temperature detection circuit 23 will be described in detail subsequently.

An operation focused on the gamma correction circuit 2 on and after the adjustment of the gamma-corrected set voltages VI₁ to VIₘ will be described next. First, the gamma-corrected set voltages VI₁ to VIₘ are adjusted to appropriate values by confirming the display of the display panel 4 in real time and inputting serial gamma correction data to the gamma correction circuit 2 via the input terminal SD from the outside. Once the adjustment is completed, the adjusted gamma correction data are saved in the nonvolatile memory 5 and the gamma correction data saved in the nonvolatile memory 5 are used subsequently. Here, the gamma correction data saved in the nonvolatile memory 5 are finely adjusted in predetermined temperature intervals (every 10° C., for example) to match the temperature characteristic of the liquid crystal display elements. More specifically, if the temperature during adjustment is a normal temperature, fine adjustment is performed in predetermined temperature intervals in accordance with the temperature characteristic of the liquid crystal display elements determined by experiment from the gamma correction data. In addition, if there are three temperatures during the adjustment, namely, the lowest temperature, normal temperature, and highest temperature, by interpolating the gamma correction data, fine adjustment can be performed at predetermined temperature intervals. The act of saving the gamma correction data in the nonvolatile memory 5 may be performed each time new gamma correction data is input from the outside rather than only when the adjustment is completed.

The gamma correction data saved in the nonvolatile memory 5 are used after the gamma-corrected set voltages VI₁ to VIₘ have been adjusted. However, in this case, the control circuit 22 of the gamma correction data output circuit 11 performs temperature detection by controlling the temperature detection circuit 23 at predetermined cycles, retrieves gamma correction data for each predetermined temperature corresponding with the detected temperature from the nonvolatile memory 5 and sends the gamma correction data to the interface circuit 21. The gamma correction data are output from the interface circuit 21 to the registers 12₁ to 12ₘ, converted into analog voltages by means of the D/A converters 13₁ to 13ₘ, and output as gamma-corrected set voltages VI₁ to VIₘ via the buffers 14₁ to 14ₘ. Here, although the predetermined cycle for temperature detection is optional, in order to update the gamma-corrected voltages VI₁ to VIₘ for one or a few screens, the cycle is preferably a cycle in sync with a cycle (approximately 16 mS, for example) that displays one screen of the display panel 4.

The control circuit 22 is capable of high-speed control if all the temperature-dependent gamma correction data are saved in the nonvolatile memory 5 and retrieved. However, gamma correction data of a reference (normal temperature, for example) and data of the differential that corresponds with the temperature can also be saved and retrieved as temperature-dependent gamma correction data, and combined and output.

Thus, the liquid crystal display device 1 is capable of performing gamma correction in accordance with the detected temperature and can provide excellent image display over a wide temperature range.

The constitution and functional operation of the temperature detection circuit 23 will be specifically described next. The temperature detection circuit 23 preferably includes a supply V_{cc}-side constant current source 24; a supply V_{cc}-side constant current source 25 which is an N multiple of the supply V_{cc}-side constant current source 24; a switch 26 that switches the connection between the temperature sensor 6 and the supply V_{cc}-side constant source 24 or supply V_{cc}-side constant current source 25; an amplifier 27 that amplifies the voltage produced in the temperature sensor 6; and an A/D converter (ADC) 28 that converts the output of the amplifier 27 to a digital value. Although a detailed description is omitted here because this is not fundamental to the present invention, when a digital value that corresponds with the voltage that is produced between the emitter and base when the current of the supply V_{cc}-side constant current source 25 flows to the temperature sensor 6 is subtracted from the digital value corresponding with the voltage that is produced between the emitter and base when the current of the supply V_{cc}-side constant current source 24 enters the temperature sensor 6, the value (temperature detection data) is A×(KT/q)×In(N). Here, K is the Bolzman constant, T is the absolute temperature, and q is the unit charge of the electrons. A is the amplification of the amplifier 27. Therefore, the control circuit 22 is able to perform temperature detection by performing the subtraction above and deriving the temperature (T) from the temperature detection data as a result. Although highly accurate temperature detection is possible when using the temperature sensor 6 and temperature detection circuit 23 described here, temperature detection can naturally be performed without being limited to this constitution.

Further, if the current output capacity of the D/A converters (DAC) 13₁ to 13ₘ is sufficient, the buffers 14₁ to 14ₘ can also be omitted.

Moreover, the present invention is not limited to the above-described preferred embodiments. A variety of design modifications within the scope of the items appearing in the claims are possible. For example, although a liquid crystal display device 1 is described in a preferred embodiment of the present invention, the gamma correction circuit and display device of the present invention are not limited to the liquid crystal display device 1 and can be applied to display devices requiring gamma correction (for example, an organic EL display device).

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-12. (canceled)

13. A gamma correction circuit which outputs a gamma-corrected set voltage to correct an image voltage in accordance with a nonlinear correlation between an applied voltage and a brightness of a display element, the gamma correction circuit comprising:
a gamma correction data output circuit arranged to output a plurality of gamma correction data in accordance with a detected temperature;
a plurality of registers arranged to input and hold a plurality of gamma correction data; and
a plurality of D/A converters each of which is arranged to convert the data of each of the plurality of registers into an analog voltage and output a gamma-corrected set voltage.

14. The gamma correction circuit according to claim 13, wherein the gamma-corrected set voltage is output via a buffer.

15. The gamma correction circuit according to claim 13, wherein the gamma correction data output circuit is arranged to output gamma correction data that are input from the outside during an adjustment of the gamma-corrected set voltage and retrieves, from a nonvolatile memory, gamma correction data corresponding with the detected temperature after the adjustment of the gamma-corrected set voltage and outputs the gamma correction data.

16. The gamma correction circuit according to claim 15, wherein the gamma correction data output circuit retrieves, from the nonvolatile memory, gamma correction data for each predetermined temperature corresponding with the detected temperature after the adjustment of the gamma-corrected set voltage and outputs the gamma correction data.

17. The gamma correction circuit according to claim 16, wherein the gamma correction data for each predetermined temperature is gamma correction data for every 10° C.

18. The gamma correction circuit according to claim 16, wherein the gamma correction data for each predetermined temperature is obtained by making normal-temperature gamma correction data match a temperature characteristic of the display element determined by experiment.

19. The gamma correction circuit according to claim 16, wherein the gamma correction data for each predetermined temperature is obtained by interpolating gamma correction data of three temperatures.

20. The gamma correction circuit according to claim 15, wherein the gamma correction data corresponding with the temperature are retrieved in their entirety from the nonvolatile memory.

21. The gamma correction circuit according to claim 15, wherein the gamma correction data corresponding with the temperature are obtained by combining one gamma correction data with data of a differential that corresponds with the temperature.

22. The gamma correction circuit according to claim 13, wherein the detection of the temperature is performed in sync with a cycle in which one screen of the display panel is displayed.

23. A display device, comprising:
the gamma correction circuit according to claim 13;
a display panel driver to which image data are input and which outputs a corrected image voltage by selecting a gamma-corrected set voltage corresponding with the image data or an interpolation voltage thereof;
a display panel which includes a display element to which the corrected image voltage from the display panel driver is applied;
a nonvolatile memory which saves a plurality of gamma correction data; and
a temperature sensor which generates an electrical signal that corresponds with a temperature and outputs the electrical signal to the gamma correction circuit.

24. The display device according to claim 23, wherein the display device is a liquid crystal display device.
